(19) United States
(12) Patent Application Publication
(10) Pub. No.: US 2017/0343148 A1
(43) Pub. Date: Nov. 30, 2017

(54) MECHANICAL INTERFACE AND METHOD FOR FASTENING COLLARS ONTO PIPE ENDS

(71) Applicant: Construction Forms, Inc., Port Washington, WI (US)

(72) Inventor: Rudiger Josef Luig, Warstein (DE)

(73) Assignee: Construction Forms, Inc., Port Washington, WI (US)

(21) Appl. No.: 15/600,907

(22) Filed: May 22, 2017

Related U.S. Application Data
(60) Provisional application No. 62/340,633, filed on May 24, 2016.

(51) Int. Cl. F16L 57/06; F16L 57/00; E04G 21/04

(52) U.S. Cl. CPC F16L 57/06; E04G 21/0418; F16L 57/005

(57) ABSTRACT

An assembly for forming a mechanical interface for fastening tubular components includes a tubular pipe having at least one end with an external surface provided with groove structure. A tubular attachment is provided with a first engagement structure configured to be aligned with the groove structure on the tubular pipe. The tubular attachment is axially force fit on the outer end of the tubular pipe, and radially fastened thereto in response to at least one tool applied to the external surface of the tubular attachment. Also disclosed is a method for forming the mechanical interface between the tubular pipe and the tubular attachment.

### CROSS-REFERENCE TO RELATED APPLICATION

The present utility application relates to and claims priority to U.S. Provisional Application Ser. No. 62/340,633 filed May 24, 2016, the disclosure of which is herein incorporated by reference in entirety.

### FIELD

The present disclosure relates generally to the formation of a joint between tubular metal components. More particularly, the present disclosure pertains to a mechanical interface formed by tools between a collar or similar attachment structure and an outer end of a pipe, such as used to convey concrete or other abrasive materials.

### BACKGROUND

The concrete pumping industry has traditionally employed long lengths of double layer pipe on mobile trucks. To facilitate interconnection of multiple pipes, it has been common practice to provide collars which are welded to outer surfaces of attachment ends of the double layer pipes. Such method of attaching the collars by welding on the ends of the double layer pipes has been successful due to low cost, simplicity and flexibility.

However, in order to provide an alternative lightweight, long-wearing and high pressure concrete handling pipe, efforts have been made to develop a heat-treated, high hardness single layer pipe. In order to attain the same performance characteristics of the double layer pipe, it is necessary to construct a single layer pipe with a high carbon steel. Because of high hardness and high carbon levels, such single layer pipes cannot be welded to collars in the same manner as with double layer pipes.

Accordingly, it is desirable to provide a mechanical fastening of collars onto the outer ends of the pipe which avoids the welding of the collars onto any external surface of the pipe, and provides a resistance to separation between the collars and the outer ends of the pipe that creates a high strength connection to meet load specifications and supply long term fatigue performance. It is also desirable to provide a mechanical fastening which is watertight between the collars and the outer ends of the pipe.

### SUMMARY

The present inventor has determined through research and development that a need exists to design and construct a mechanical interface for supplying outer ends of pipes with collars or similar attachments fixed thereto such that the collars are not welded directly to the external surface of the pipe.

In order to provide the mechanical interface, external surfaces at the outer ends of the high hardness pipe are modified by machining, grinding, threading or supplying any other physical change. This change to the surface is as minimal as possible, but must be significant enough to create an attachment area that is strong enough to survive the pressure and mechanical forces subjected upon the pipe during its use. The main reason for the minimal physical change to the external surface at the pipe outer ends is that the modified attachment area is prone to wear away throughout the lifetime of the pipe. The more material that is removed from the outer ends of the pipe, the greater the potential for problems resulting in the pipe wearing out sooner and/or handling less pressure.

Each collar may be machined or grooved and is designed to be initially slid and/or axially pressed or force fit onto the modified outer end of the pipe. Then, the collar is squeezed radially upon the modified outer end of the pipe, i.e. shrunken down by a press, weld heat, locking ring or roll forming tool causing a mechanical fixed engagement between the pipe and the collar. Glue and/or a gasket can be provided between the collar and the outer end of the pipe to provide a stronger, water tight connection.

In some cases, a split ring is axially forced onto a modified outer end of the pipe after which a collar is axially pressed onto a split ring, and a weld seam is applied between a shoulder of the split ring and an inner end of the collar without welding on the external surface of the pipe.

In one aspect of the disclosure, an assembly defines a mechanical interface for fastening tubular components. The assembly includes an elongated tubular pipe having at least one outer end with an external surface provided with groove structure. A tubular attachment is provided with first engagement structure configured to be aligned with the groove structure on the tubular pipe. The tubular attachment is force fit on the outer end of the tubular pipe, and radially fastened thereto in response to at least one tool applied to the external surface of the tubular attachment.

In another aspect of the present disclosure, there is contemplated a method for forming a mechanical interface between an outer end of a tubular pipe, and a tubular attachment. The method includes the steps of: a) providing an external surface at the outer end of the tubular pipe with groove structure; b) providing the tubular attachment with first engagement structure configured to be aligned with the groove structure on the tubular pipe; c) axially pressing the tubular attachment onto the outer end of the tubular pipe over the groove structure; and d) radially fastening the tubular attachment to the outer end of the tubular pipe by using a tool for applying at least one of a radial force and welding the tubular attachment outside and out of contact with the external surface of the tubular pipe.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view of an assembly of a mechanical interface for fastening tubular components in accordance with the present disclosure.

FIG. 2 is an exploded view of one end of the assembly shown in FIG. 1.

FIGS. 3 and 4 are sectional views of one end of the assembly of FIG. 1.

FIG. 5 is a sectional view showing the formation of the assembly shown in FIGS. 3 and 4.

FIG. 6 is an isometric view of another assembly showing a mechanical interface.

FIG. 7 is an exploded view of one end of the assembly of FIG. 6.

FIGS. 8 and 9 are sectional views of one end of an assembly employing slanted faces of projections and grooves on the collar and the pipe.

FIG. 10 is an exploded view of one end of a further assembly.

FIGS. 11 and 12 are sectional views of one end of the assembly employing rounded or annular projections and grooves on the collar and the pipe.

FIG. 13 is an isometric view of another assembly of a mechanical interface utilizing welding to secure a collar onto a pipe.

FIG. 14 is an exploded view of one end of the assembly of FIG. 13.

FIGS. 15 and 16 are sectional views of the assembly of FIG. 13.

FIG. 17 is an isometric view of an additional assembly using a split ring.

FIG. 18 is an exploded view of the assembly of FIG. 17.

FIG. 19 is a sectional view of the assembly of FIG. 17.

FIG. 20 is an exploded view of yet another assembly for securing a collar onto a pipe.

FIG. 21 is a sectional view showing the assembly of FIG. 20.

FIG. 22 shows an example of an axial pressing tool used in forming some of the assemblies.

FIGS. 23 and 24 show an example of a crimping die used in forming some of the assemblies.

FIG. 25 shows an example of a welding tool used in forming some of the assemblies.

### DETAILED DESCRIPTION

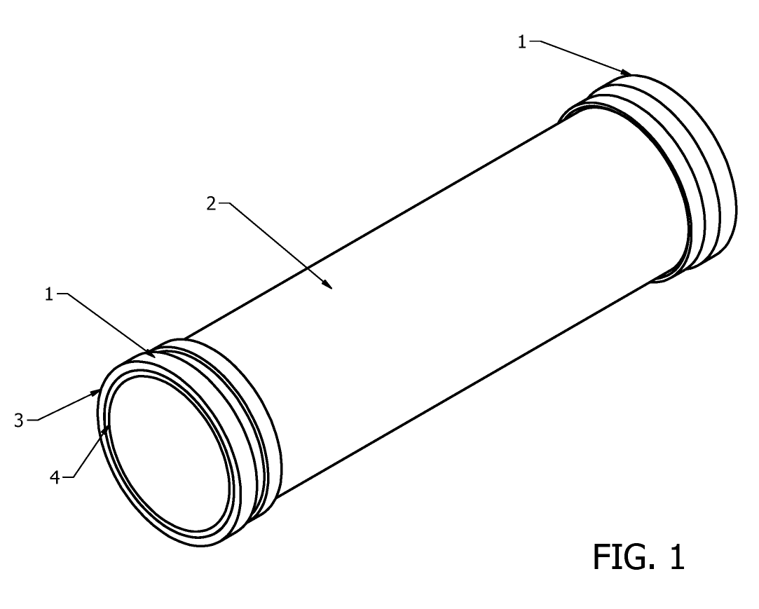

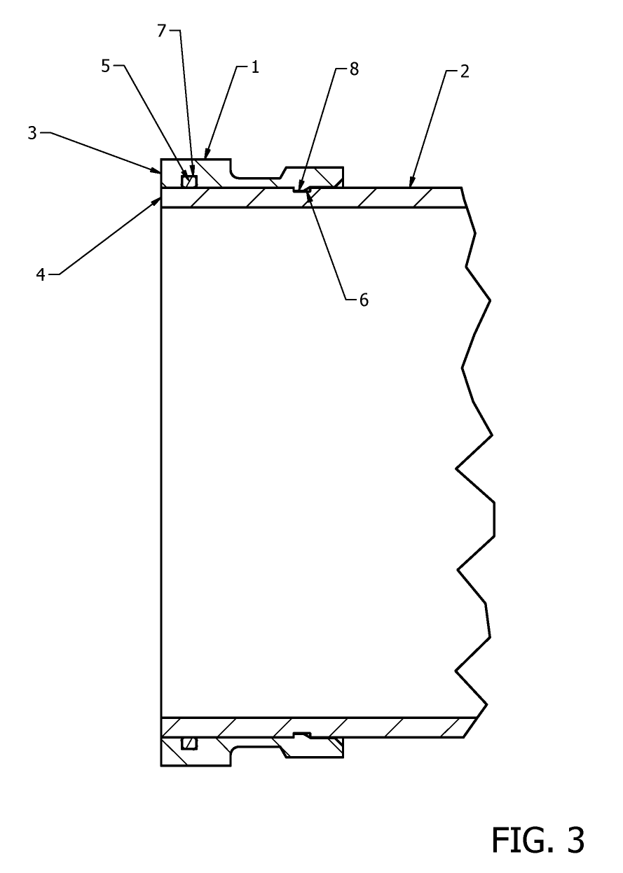

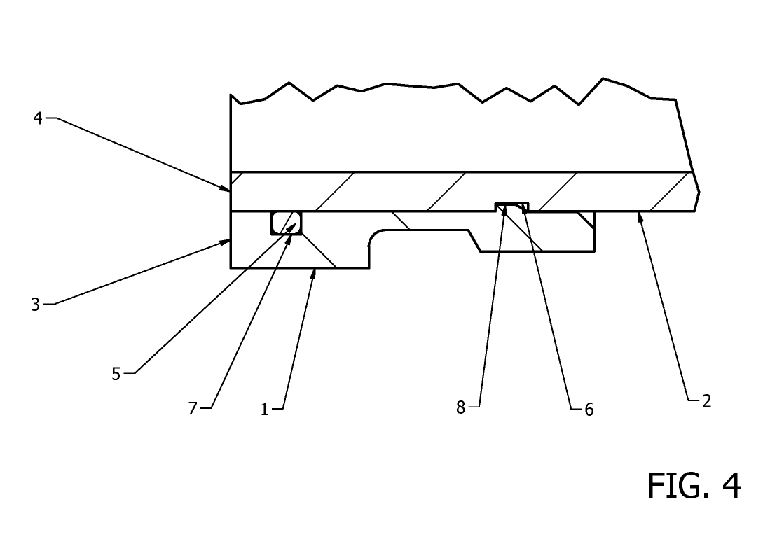

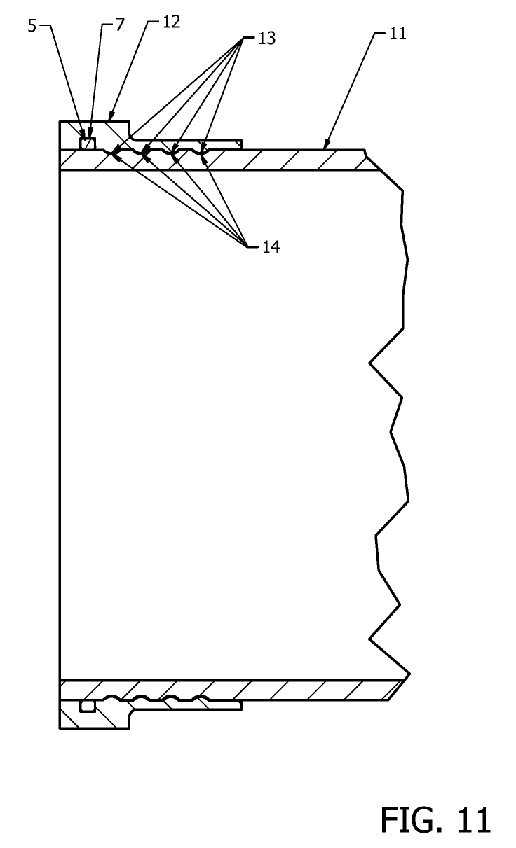

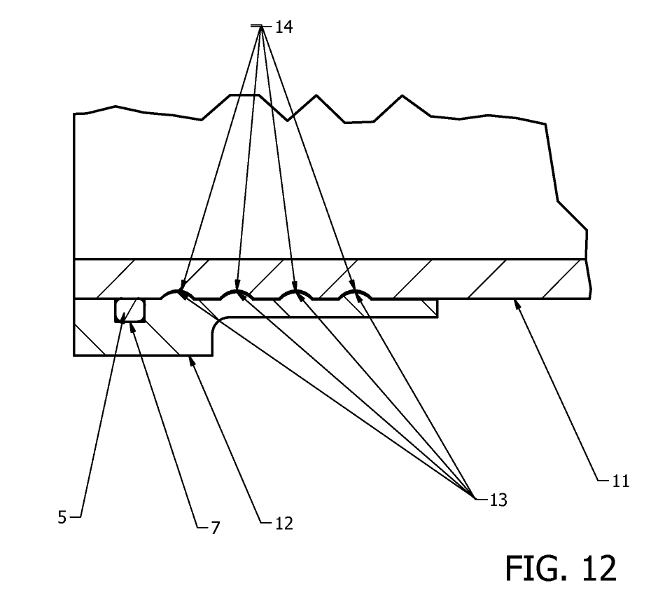

Referring now to the drawings, FIGS. 1-25 show the formation of various embodiments of a mechanical interface for fastening a tubular collar or attachment onto an outer end of a tubular pipe. In each embodiment shown, the pipe is an elongated hardened single layer pipe formed preferably of a high carbon steel such as C60. As will be described below, each pipe has opposite open outer ends which are modified on external surfaces thereof, such as with one or more grooves, to form attachment points for collars or other ring-like attachments.

Referring now to the drawings, FIG. 1 illustrates an assembly defining a mechanical interface for fastening tubular components. The assembly includes a tubular attachment defined by a cylindrical pipe end or collar 1 which is attached on opposite ends of a single layer tubular pipe 2. The collar 1 and the pipe 2 are provided with respective end faces 3 and 4.

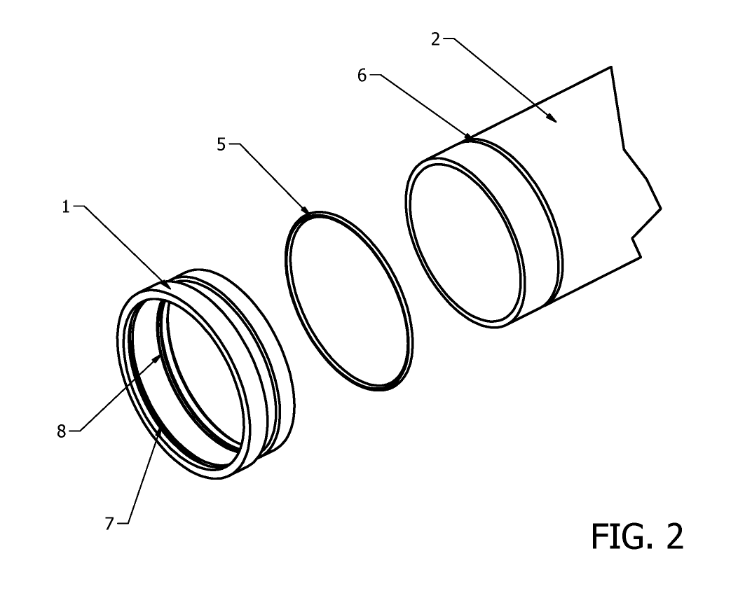

As seen in FIGS. 2-4 which show several views of one end of the assembly in FIG. 1, an internal surface of the collar 1 includes a sealing ring groove 7 configured to receive a gasket or sealing ring 5, and a first engagement structure 8 formed by a single projection which is designed to fit into a first groove structure 6 provided by a single annular groove formed on an external surface of the pipe 2.

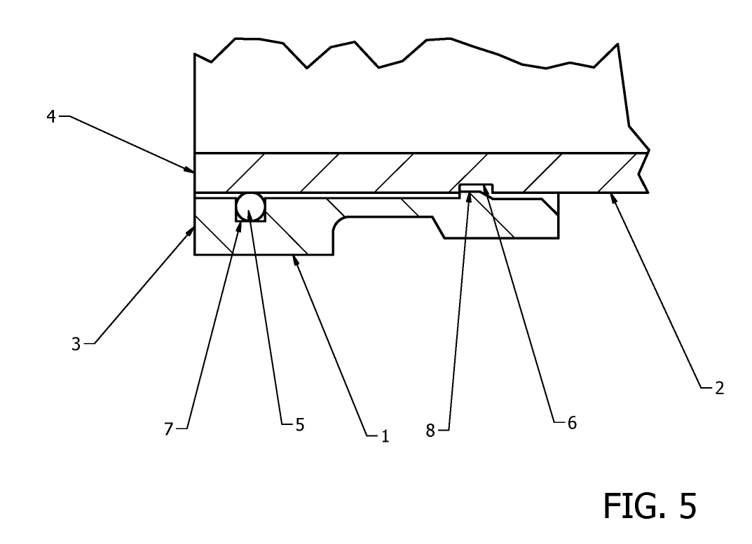

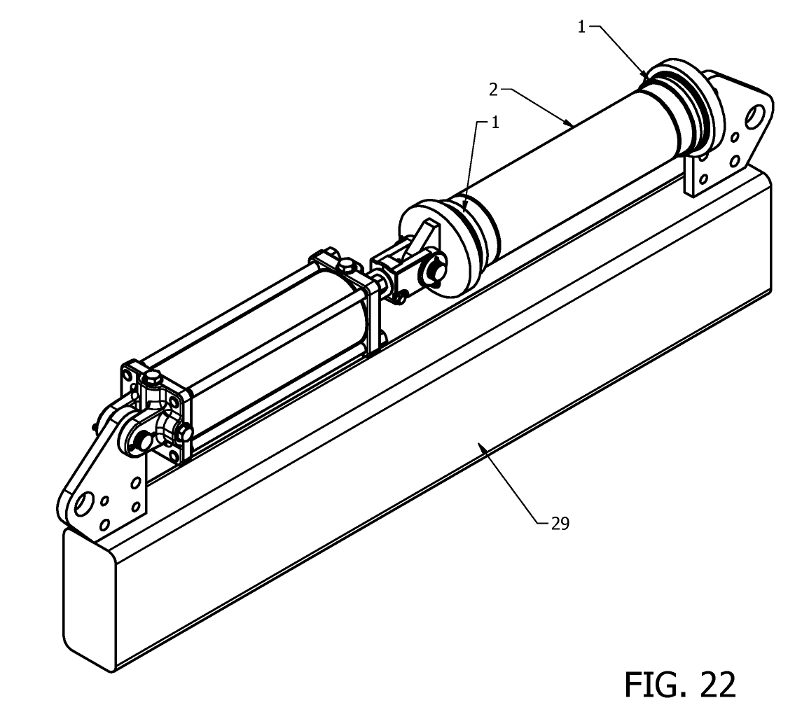

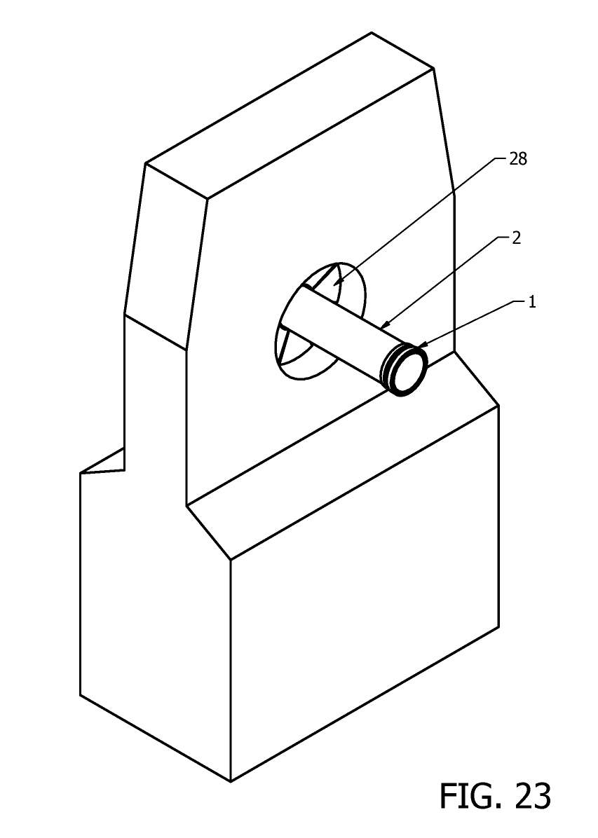

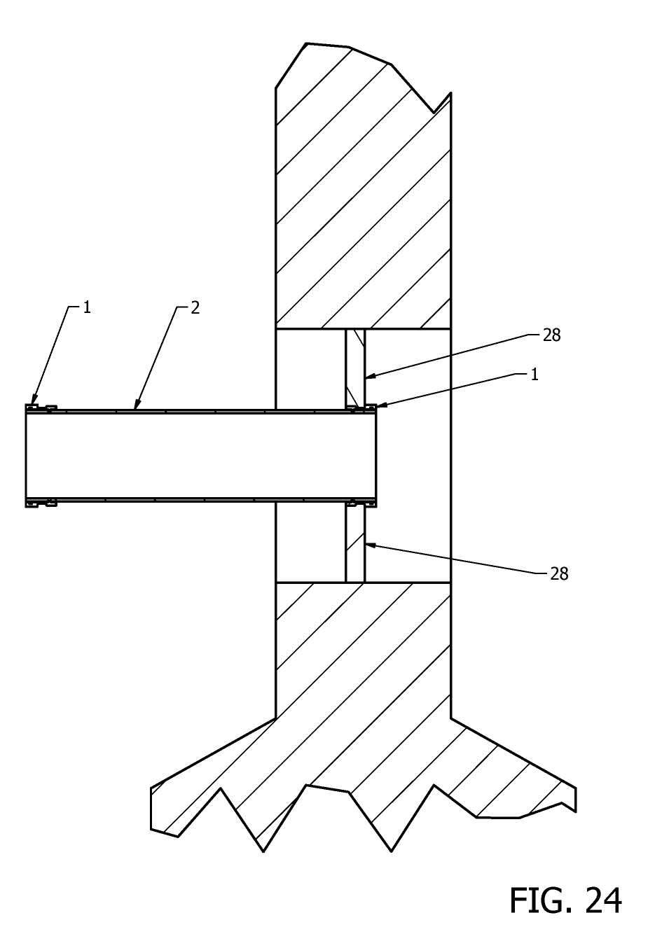

Referring now to FIG. 5, in forming the assembly shown in FIGS. 1-4, the collar 1 with the gasket 5 is axially pressed onto the end of the pipe 2 such as, for example, by an axial pressing tool 29 shown in FIG. 22. Then, a radial force is applied to the collar 1, such as by using a crimping die 28 illustrated in FIGS. 23 and 24. Application of a radial force closes any gap or space between the inner surface of the collar 1 and the outer surface of the pipe 2 to place the projection 8 in the groove 6 and attain the mechanical interface retaining the collar on the end of the pipe 1. The disclosure contemplates the use of alternative means for axially and radially pressing the collar 2 relative to the end of the pipe 1 to secure the collar 2 and pipe 1 together.

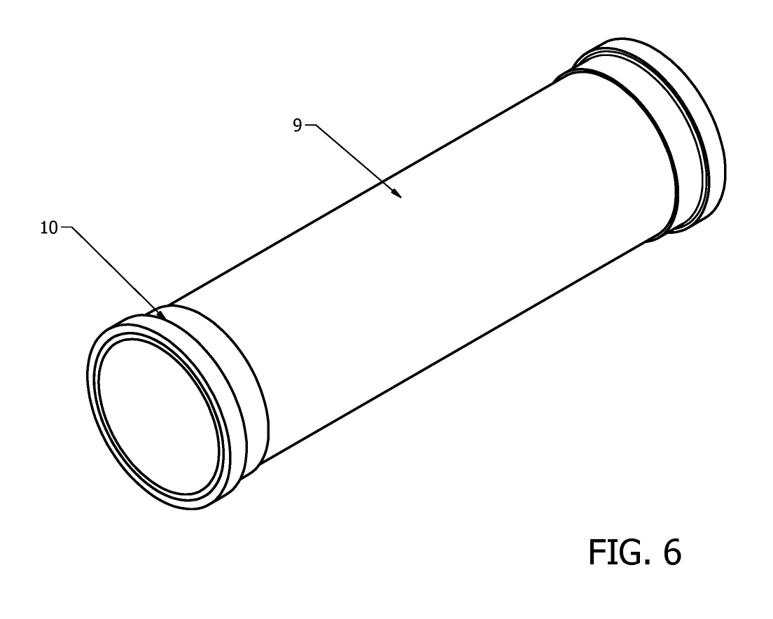

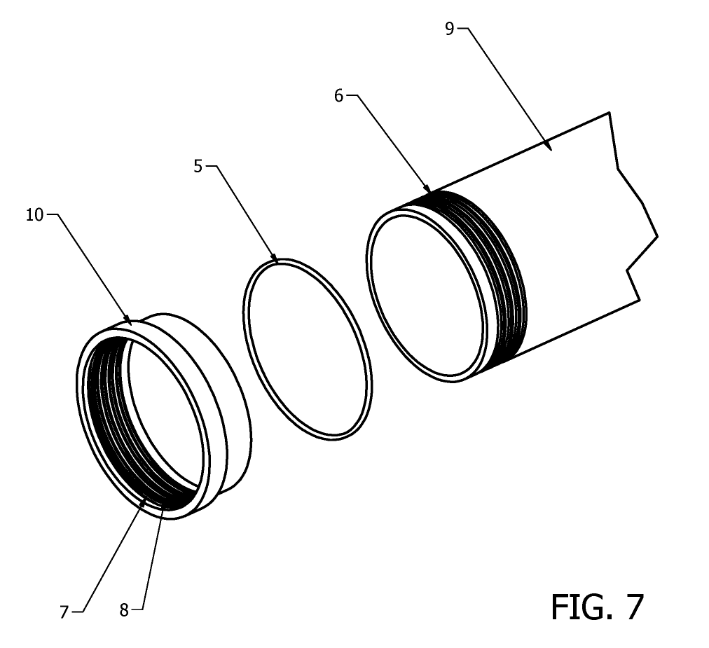

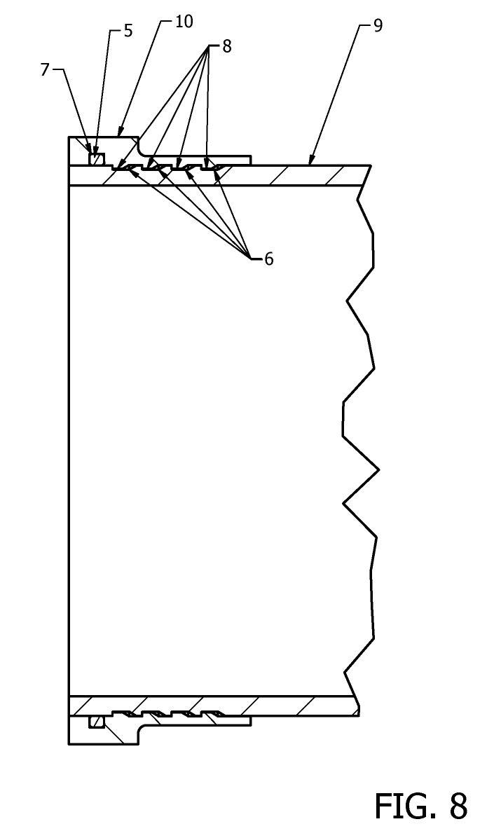

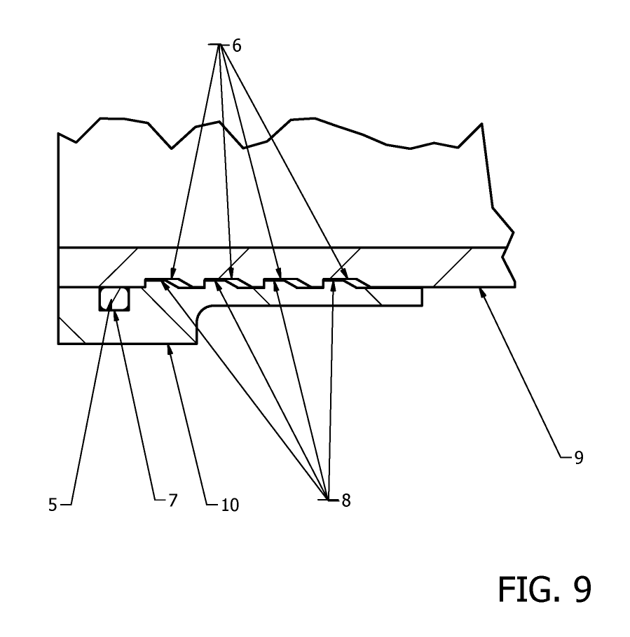

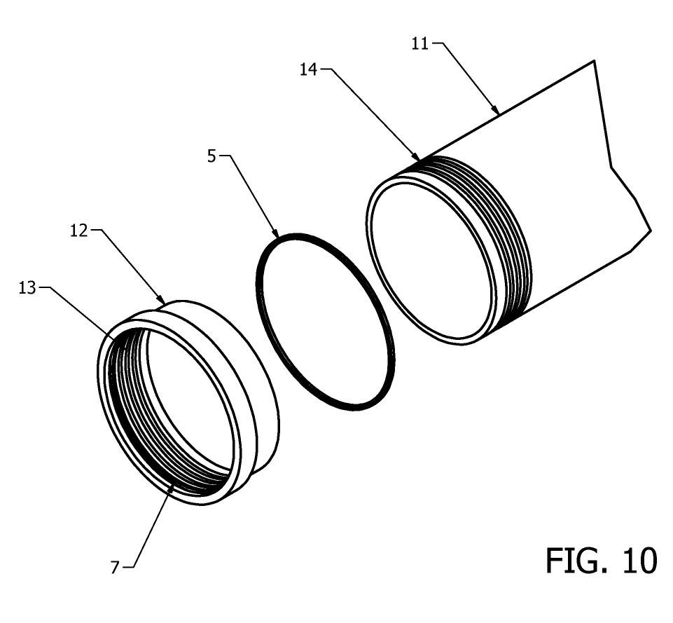

FIGS. 6 and 7 show another assembly defining a mechanical interface for fastening a collar 10 onto a pipe 9. In this embodiment, the first groove structure 6 on the pipe 9 is provided by a series of grooves, and the first engagement structure 8 on the collar 10 is provided by a series of projections. FIGS. 8 and 9 illustrate that the grooves 6 and the projections 8 have slanted faces. In the embodiments of FIGS. 10-12, the first groove structure on the pipe 11 is formed by a series of rounded or annular grooves 14. The first engagement structure on the collar 12 is formed by a series of round or annular projections 13. Formation of the assembly of FIGS. 6, 11 and 12 is similar to the assembly formation of the embodiment of FIG. 1.

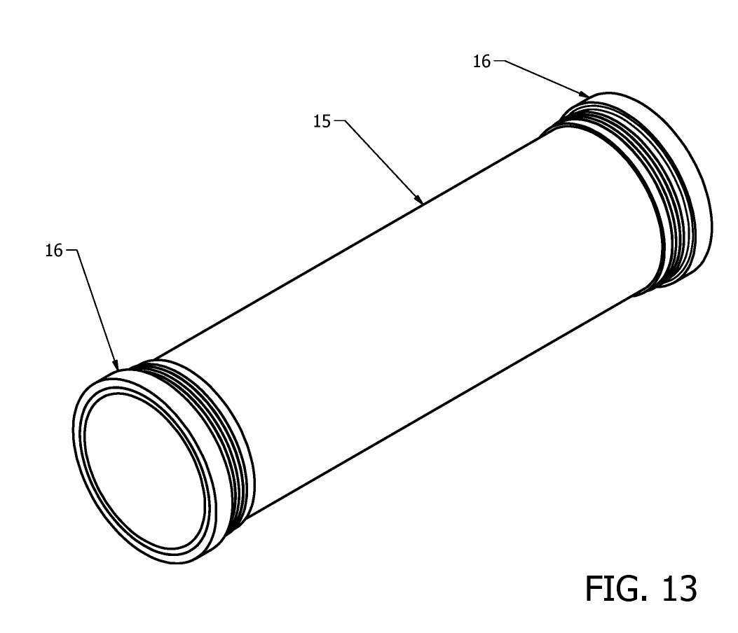

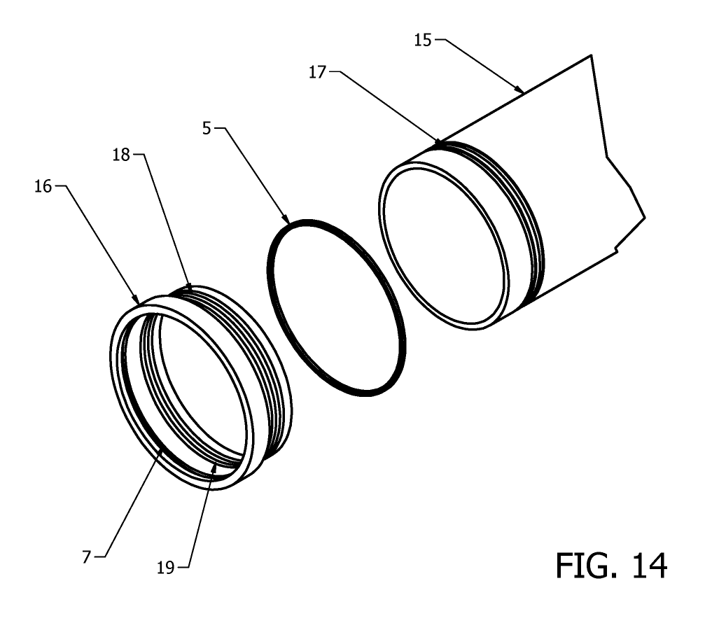

FIG. 13 shows a further assembly defining a mechanical interface for fastening a collar 16 onto opposite ends of a pipe 15. In this embodiment, as shown in FIG. 14, the first groove structure on the pipe 15 is formed by weld grooves 17. The first engagement structure on the collar 16 includes a series of weld grooves 18 on the collar outer surface, and a second engagement structure formed by a series of projections 19 on the collar inner surface. The weld grooves 17 and 18 are designed to be aligned with each other, and the projections 19 are configured to be aligned with the weld grooves 17.

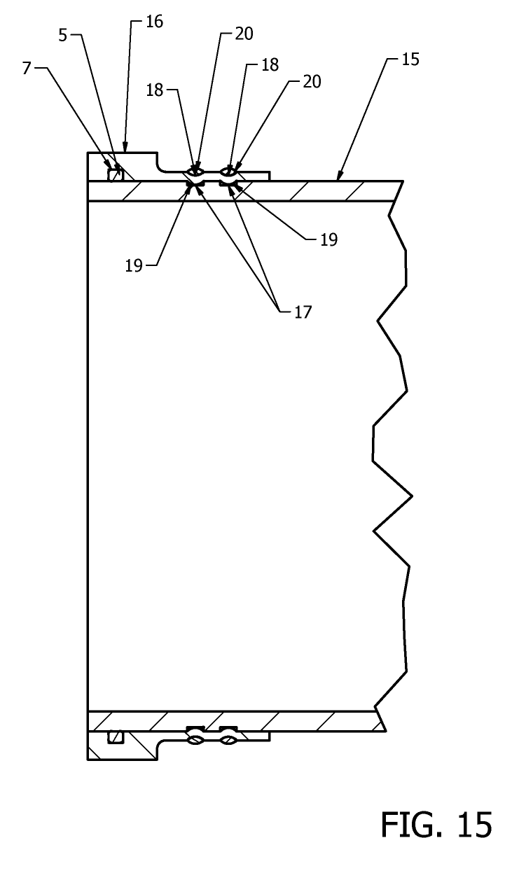

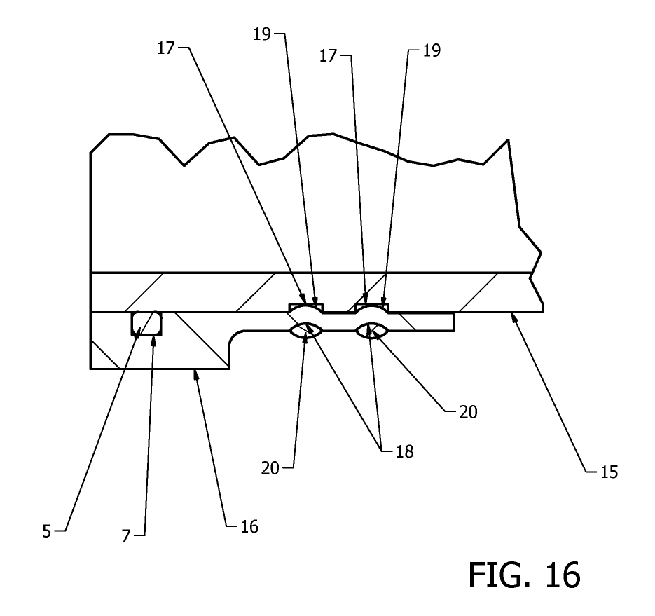

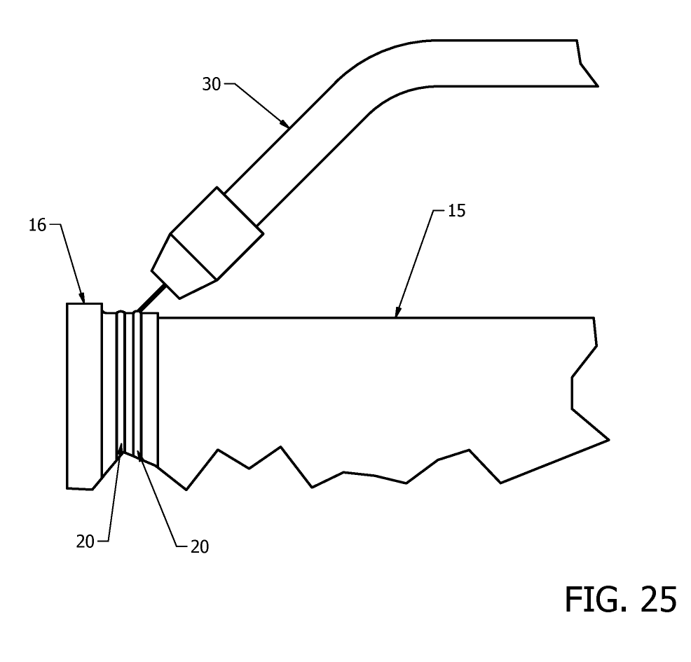

To form the assembly of FIG. 13, the collar 16 with the gasket 5 is axially pressed onto the end of the pipe 15. Then, compression welds 20 (FIGS. 15 and 16) are applied in the weld grooves 18 by a welding tool 30 (FIG. 25) causing the projections 19 to be engaged within the weld grooves 17 to secure the collar 16 to the end of the pipe 15.

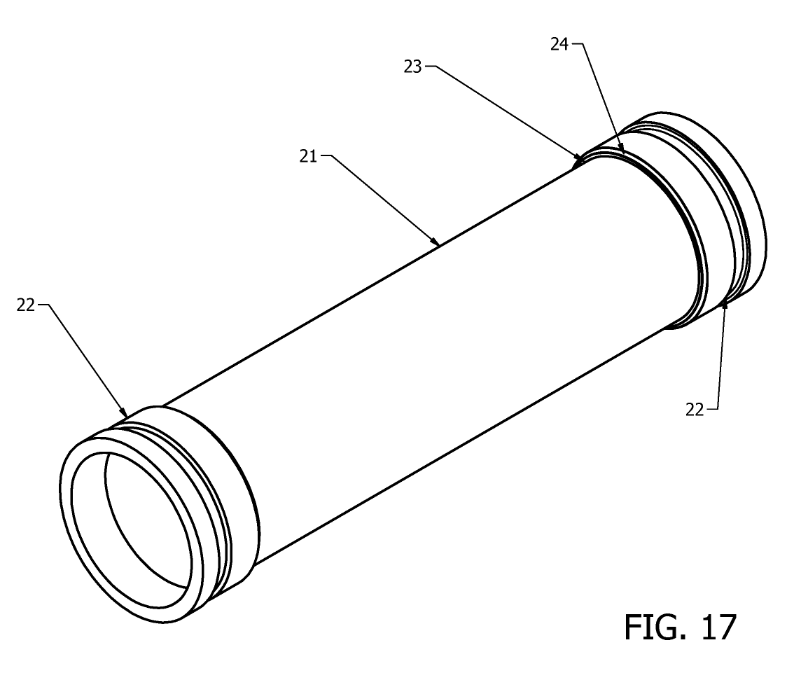

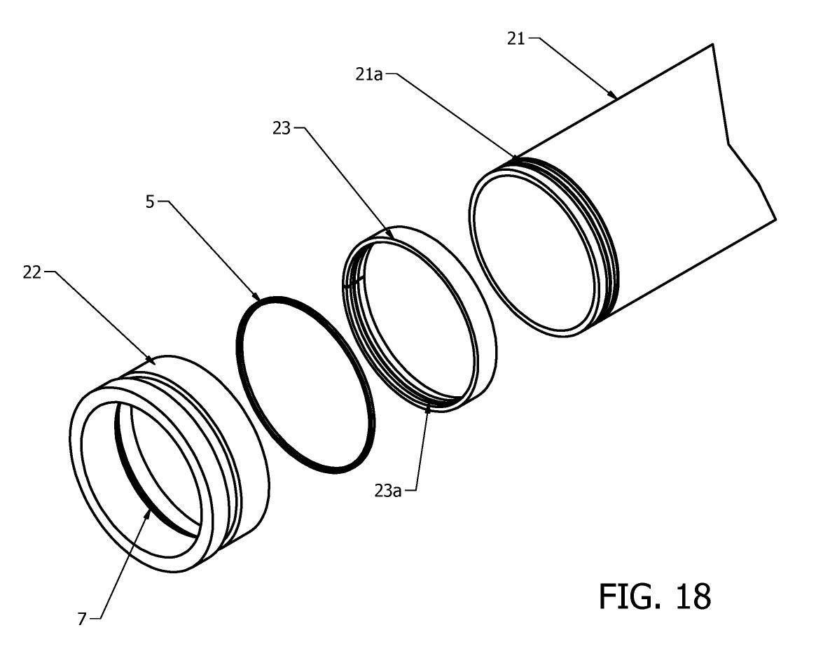

FIG. 17 shows an additional assembly defining a mechanical interface for fastening a collar 22 onto opposite ends of a pipe 21. As also seen in FIG. 18, the tubular attachment includes the collar 22, and a split ring 23 having an internal surface provided with projections 23a defining second engagement structure configured to be received and retained in grooves 21a formed in the pipe 21.

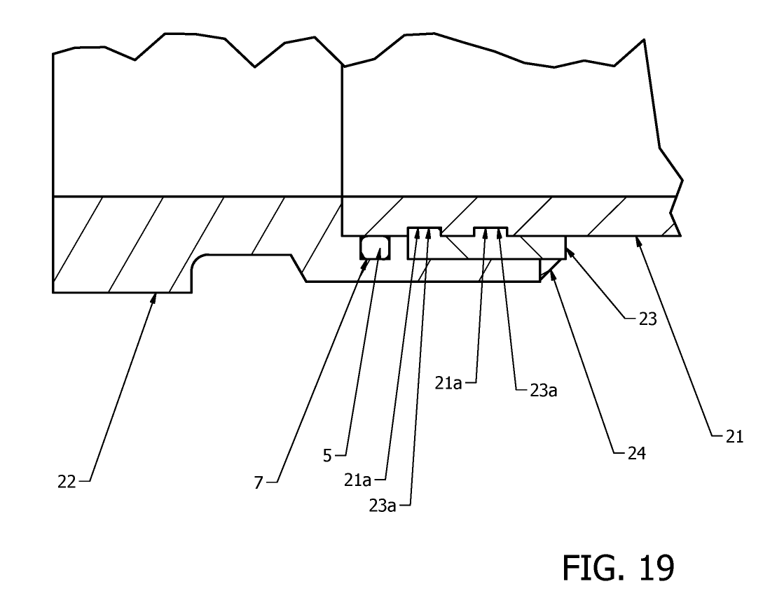

Referring to FIG. 19, to form the assembly of FIG. 17, the split ring 23 is axially and radially pressed onto the end of the pipe 21 after which the collar 22 with gasket 5 is axially pressed against the outer end of the pipe 21 and over the outer surface of the split ring 23. At this point, a locking weld 24 is applied, such as by the welding tool 30, between ends of the collar 22 and the split ring 23. No weld is applied to the outer surface of the pipe 21.

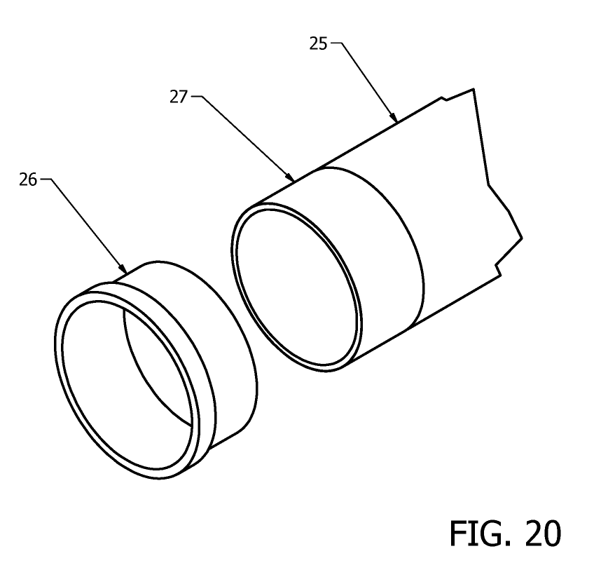

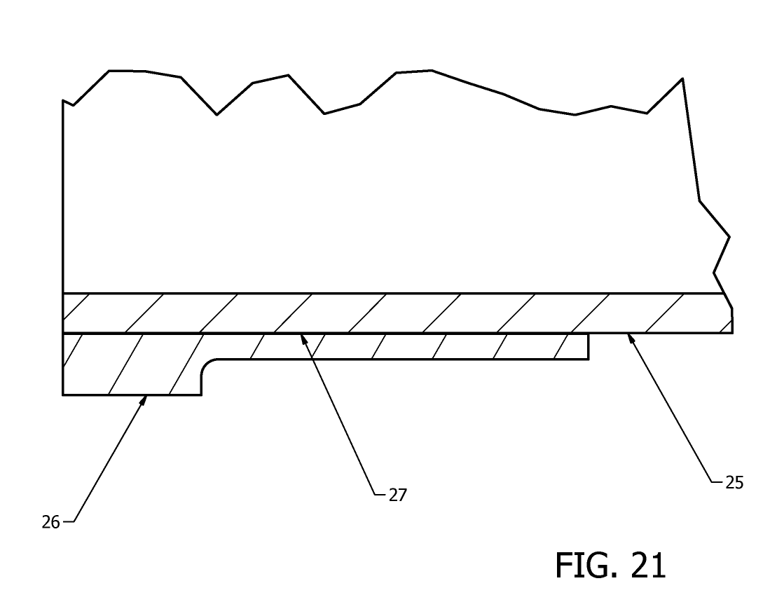

FIGS. 20 and 21 show an alternative assembly wherein the mechanical interface is formed by applying adhesive 27 to an end area of the pipe 25, and then axially pressing the collar 26 onto the glued end of the pipe 25 to secure the collar 26 on pipe 25.

In FIGS. 1-25, it should be understood that the collar or the combination of the collar and the split ring define the tubular attachment fastened to the outer end of the pipe.

In the present disclosure, certain terms have been used for brevity, clearness and understanding. No unnecessary limitations are to be implied therefrom beyond the requirement of the prior art because such terms are used for descriptive purposes only and are intended to be broadly construed. The different systems and methods defined herein may be used alone or in combination with other systems and devices. Various equivalents, alternatives and modifications are possible within the scope of the appended claims.

What is claimed is:

1. An assembly defining a mechanical interface for fastening tubular components, the assembly comprising:
an elongated tubular pipe having at least one end with an external surface provided with groove structure; and
a tubular attachment provided with first engagement structure configured to be aligned with the groove structure on the tubular pipe,
wherein the tubular attachment is axially force fit on the outer end of the tubular pipe, and radially fastened thereto in response to at least one tool applied to the external surface of the tubular attachment.

2. The assembly of claim 1, wherein the tubular attachment has an internal surface and an external surface, one of the internal surface and the external surface being provided with either grooves or projections forming the first engagement structure.

3. The assembly of claim 1, wherein the at least one tool is selected from a group comprising a pressing tool and a welding tool.

4. The assembly of claim 1, wherein the tubular attachment is formed by a collar.

5. The assembly of claim 1, wherein the tubular attachment is formed by a split ring and a collar positioned over the split ring.

6. The assembly of claim 1, wherein the groove structure on the tubular pipe and the first engagement structure on the tubular attachment have complementary slanted faces engageable with one another.

7. The assembly of claim 1, wherein the groove structure on the tubular pipe and the first engagement structure on the tubular attachment have complementary annular faces engageable with one another.

8. The assembly of claim 1, wherein the groove structure on the tubular pipe includes at least one groove.

9. The assembly of claim 1, wherein adhesive is provided between the tubular pipe and the tubular attachment.

10. The assembly of claim 1, wherein a gasket is provided between the tubular pipe and the tubular attachment.

11. The assembly of claim 1, wherein the tubular pipe is constructed of a single layer of material.

12. The assembly of claim 5, wherein the split ring has an internal surface provided with second engagement structure engageable with the groove structure on the tubular pipe.

13. The assembly of claim 1, wherein the tubular pipe and the tubular attachment are fastened together without application of welding to the external surface of the tubular pipe.

14. A method for forming a mechanical interface between an outer end of a tubular pipe and a tubular attachment, the method comprising the steps of:
a) providing an external surface at the outer end of the tubular pipe with groove structure;
b) providing the tubular attachment with first engagement structure configured to be aligned with the groove structure on the tubular pipe;
c) axially pressing the tubular attachment onto the outer end of the tubular pipe over the groove structure; and
d) radially fastening the tubular attachment to the outer end of the tubular pipe by using a tool for applying at least one of radial force and welding to the tubular attachment outside and out of contact with the external surface of the tubular pipe.

15. The method of claim 14, wherein the tubular attachment has an internal surface and an external surface, one of the internal surface and the external surface being provided with either grooves or projections forming the first engagement structure.

16. The method of claim 14, wherein the tool is selected from a group comprising a pressing tool and a weld forming tool.

17. The method of claim 14, wherein the tubular attachment is formed by a collar.

18. The method of claim 14, wherein the tubular attachment is formed by a split ring and a collar positioned over the split ring.

19. The method of claim 14, wherein at least one of adhesive and a gasket is provided between the tubular pipe and the tubular attachment.

20. The method of claim 14, wherein, in step d), the tubular attachment and the tubular pipe are fastened together without applying welding to the external surface of the tubular pipe.
